(19) United States
(12) Patent Application Publication
(10) Pub. No.: US 2022/0318514 A1
(43) Pub. Date: Oct. 6, 2022

(54) SYSTEM AND METHOD FOR IDENTIFYING ENTITIES AND SEMANTIC RELATIONS BETWEEN ONE OR MORE SENTENCES

(71) Applicant: Gnani Innovations Private Limited, Bengaluru (IN)

(72) Inventor: Armaan PURI, Bengaluru (IN)

(21) Appl. No.: 17/570,762

(22) Filed: Jan. 7, 2022

(30) Foreign Application Priority Data
Mar. 30, 2021 (IN) 202141014161

(51) Int. Cl. G06F 40/30; G06F 40/205; G06F 40/295; G10L 15/26

(52) U.S. Cl. CPC G06F 40/30; G06F 40/205; G06F 40/295; G10L 15/26

(57) ABSTRACT

The present disclosure pertains to a system (102), and a method (400) for identifying entities and semantic relation between one or more sentences. The system (102) can include a voice to text converter (106), a processor (202), and an output device (108). The processer (202) can be configured to receive one or more sentences from the voice to text converter (106), and extract a pre-defined category pertaining to one or more entities, where the processor is configured to calculate a semantic relation based on the masked out each of one or more entities and facilitates computing semantic similarity and pre-defined category-wise each of the one or more entities difference between the one or more sentences, where the processor (202) can be configured to calculate semantic relation in multiple languages. The processor (202) can be configured to transmit the calculated semantic relation to the output device (108) enables displaying the difference between the one or more sentences.

### TECHNICAL FIELD

The present disclosure relates to the field of semantic relations identification. More particularly, the present disclosure relates to system for identifying entities and semantic relations between one or more sentences.

### BACKGROUND

Background description includes information that may be useful in understanding the present invention. It is not an admission that any of the information provided herein is prior art or relevant to the presently claimed invention, or that any publication specifically or implicitly referenced is prior art.

Semantic similarity between sentences (SBERT), semantic similarity between named entities (Google Directory) is problematic and difficult to identify.

There is no direct work on minimizing undesirable effect of entities on semantic meaning and subsequent comparison between sentences. Treating entities as separate objects will not influence semantic meaning. Entities when treated like semantically meaningful words can cause confusion. Ability to identify why two sentences are dissimilar (semantically different or entity based difference) enables in appropriately identifying similar/dissimilar sentences along with appropriate cause.

Existing solutions on semantic similarity deals with mostly entity free sentences to detect similarity. However, entities are a large part of any language and if used in similarly constructed sentences, do not change meaning of the sentence. For eg, sentences involving a person's name like “Raj is a good student”, “Mohan is a good student” and “Kumar is a good student” should all have equal semantic similarity which is not the case in current art. Similarly, sentences involving numbers, do not essentially change the semantic meaning but are interpreted as such in current methodologies. For example—Eg: 2 sentences such as “I acquired a loan of 25,00,000 from HDFC” and “I acquired a loan of 3,00,000 from ICICI” should be semantically similar but since it is very hard for current semantic system to understand entities and to deal with them, scores may vary as different loan amounts/banks are mentioned.

Various solutions can be proposed which includes method to extract document summaries, essentially, extracting most meaningful sentences in a document with limited repetition of meaning among sentences. However, their sentence comparison does not account for semantic confusion caused by entities. They compare entities but do not account for cases where entities could be the same but semantic meaning around the entities different. This methodology would still face problems with separating entities and context around entities, like other contemporary approaches since they're looking at whether 2 sentences mention different entities. Another solution can include Entity and semantic relation recognition method and device, electronic equipment and storage medium, where encoding step does not account for solving semantic confusion and emphasizes on encoding and decoding of sentences. Another solution can include entity similarity/comparison and does not disclose about semantic/meaning of the sentences around the entities. Another solution can include entity recognition training method. However, does not disclose entity comparison or semantic comparison. This does not seem to address either entity comparison or semantic comparison in any way.

There is therefore a need in an existing art for a solution that can facilitate identification of entities and semantic relation between one or more sentences. The solution facilitates identifying why two sentences are dissimilar (semantically different or entity based difference) enables in appropriately identifying similar/dissimilar sentences along with appropriate cause. Also, the solution helps in providing detailed level of comparison for two sentences rather than relying on a single number which tries to account for both semantic and entity difference and enables in leveraging cross lingual language solution to provide this level of detail even for low resource languages.

### Objects of the Present Disclosure

Some of the objects of the present disclosure, which at least one embodiment herein satisfies are as listed herein below.

It is an object of the present disclosure to provide a system and method for identifying entities and semantic relations which has low training data requirement and where by fine tuning of an architecture in single language, inference in more than hundred languages is obtained.

It is an object of the present disclosure to provide a system and method that helps named entity recognition with cross lingual pre-training to reliably attain semantic learning for multiple languages.

It is an object of the present disclosure to provide a system and method that facilitates much detailed level of comparison for two sentences rather than relying on a single number which tries to account for both semantic and entity difference and enables in leveraging cross lingual language solution to provide this level of detail even for low resource languages.

It is an object of the present disclosure to provide a system and method that enables in identifying why two sentences are dissimilar (semantically different or entity based difference) and enables in appropriately identifying similar/dissimilar sentences along with appropriate cause.

It is an object of the present disclosure to provide a system and method for identifying entities and semantic relation where entities are handled separately and do not effect meaning of the sentence.

It is an object of the present disclosure to provide a system and method for identifying entities and semantic relation where same network is extended to provide an improved paraphrase mining solution.

### SUMMARY

The present disclosure relates to the field of semantic relations identification. More particularly, the present disclosure relates to system for identifying entities and semantic relations between one or more sentences.

An aspect of the present disclosure pertains to a system for identifying one or more entities and semantic relations between one or more sentences. The system may include a voice to text converter, a processor, and an output device. The voice to text converter may be configured to receive an audio signal pertaining to speech from a first entity, and correspondingly convert the audio signals into the one or more sentences and correspondingly generate a first set of signals. The processor may be communication with the voice to text converter, where the processor may be operatively coupled to Entity agnostic semantic engine, where the processor may include a memory storing instructions executable by the processor. The processor may be configured to extract pre-defined categories from the first set of signals, where the pre-defined categories may include one or more entities. The processor may be configured to classify the pre-defined categories by assigning a pre-defined weight, where the pre-defined weight may pertain to trainable parameters. The processor may be configured to mask out each of the classified one or more entities of the pre-defined categories with a dataset, where the dataset may includes pre-stored filler alphanumeric characters for each of the one or more entities of the pre-defined categories. The processor may be configured to calculate a semantic relation based on the masked out each of the one or more entities and facilitates computing semantic similarity and pre-defined category-wise each of the one or more entities difference between the one or more sentences, where the processor may be configured to calculate semantic relation in multiple languages. The processor may be configured to transmit the calculated semantic relation to the output device communicatively coupled to the processor, where the output device may enable displaying the difference between the one or more sentences.

In an aspect, the pre-defined categories may include any or a combination of person names, organizations, locations, medical codes, time expressions, quantities, monetary values, percentages, numeral,

In an aspect, the one or more entities may include any or a combination of noun, vowel, consonant, pronoun, digit.

In an aspect, the pre-stored filler alphanumeric characters may include any or a combination of number, and alphabet to replace the one or more entities of similar pre-defined categories.

In an aspect, the semantic relation may include semantic similarity and pre-defined category-wise each of the one or more entities difference between the one or more sentences, where the difference may include semantic difference or entity based difference.

In an aspect, the processor may be configured to capture one or more sentences which are semantically similar and mention different entities, semantically different and mention same entities, semantically similar with same entities and also the one or more sentences dissimilar semantically and entity wise.

In an aspect, the output device may include one or more mobile computing devices, where the one or more mobile computing device may include any or a combination of cell phone, laptop, and digital handheld portable device.

Another aspect of the present disclosure pertains to a method for identifying one or more entities and semantic relations between one or more sentences. The method may include receiving, at a voice to text converter, an audio signal pertaining to speech from a first entity and correspondingly convert the audio signals into the one or more sentences and correspondingly generate a first set of signals. The method may include extracting, at a processor operatively coupled to the voice to text converter, where the processor may be operatively coupled to an Entity agnostic semantic engine, where the processor may include a memory storing instructions executable by the processor, pre-defined categories from the first set of signals, where the pre-defined categories may include one or more entities. The method may include classifying, at the processor, the pre-defined categories by assigning a pre-defined weight, where the pre-defined weight may pertain to trainable parameters. The method may include masking out, at the processor, each of the classified one or more entities of the pre-defined categories with a dataset, where the dataset may include pre-stored filler alphanumeric characters for each of the one or more entities of the pre-defined categories. The method may include calculating, at the processor, a semantic relation based on the masked out each of the one or more entities and facilitates computing semantic similarity and pre-defined category-wise each of the one or more entities difference between the one or more sentences, where the processor may be configured to calculate semantic relation in multiple languages. The method may include transmitting, at an output device communicatively coupled to the processor, the calculated semantic relation, where the output device may enable displaying the difference between the one or more sentences.

In an aspect, the semantic relation may include semantic similarity and pre-defined category-wise each of the one or more entities difference between the one or more sentences, where the difference may include semantic difference or one or more entities based difference.

In an aspect, the processor may be configured to capture one or more sentences which are semantically similar and mention different one or more entities, semantically different and mention same one or more entities, semantically similar with same one or more entities and also the one or more sentences dissimilar semantically and one or more entities wise.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates network architecture of proposed system for identifying entities and semantic relations between one or more sentences, to elaborate upon its working in accordance with an embodiment of the present disclosure.

FIG. 2 and FIG. 3 illustrate exemplary functional components of the proposed system for identifying entities and semantic relations between one or more sentences, in accordance with an embodiment of the present disclosure.

FIG. 4 illustrates an exemplary proposed method for identifying entities and semantic relations between one or more sentences, in accordance with an embodiment of the present disclosure.

FIG. 5 illustrates an exemplary computer system in which or with which embodiments of the present invention can be utilized in accordance with embodiments of the present disclosure.

### DETAIL DESCRIPTION

In the following description, numerous specific details are set forth in order to provide a thorough understanding of embodiments of the present invention. It will be apparent to one skilled in the art that embodiments of the present invention may be practiced without some of these specific details.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

The present disclosure relates to the field of semantic relations identification. More particularly, the present disclosure relates to system for identifying entities and semantic relations between one or more sentences.

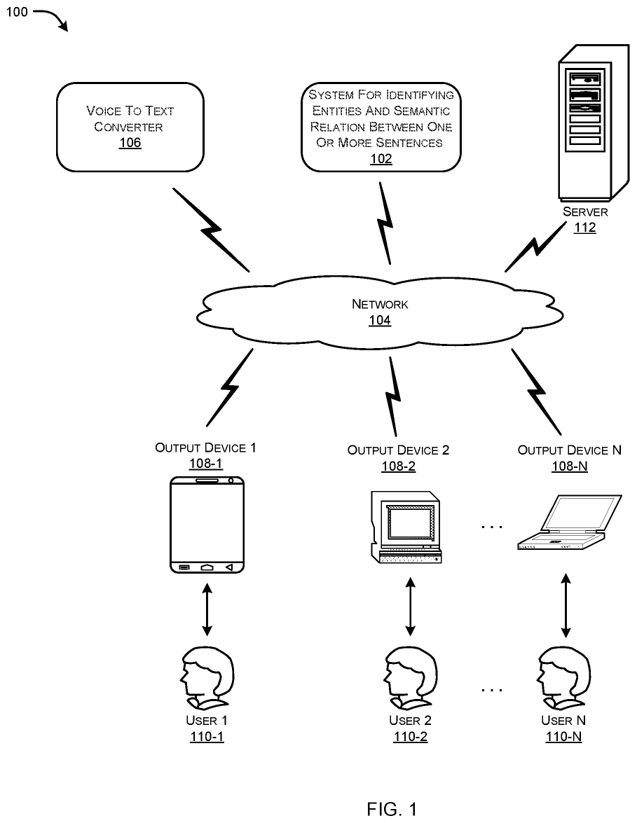

FIG. 1 illustrates network architecture of proposed system for identifying entities and semantic relations between one or more sentences, to elaborate upon its working in accordance with an embodiment of the present disclosure.

As illustrated in FIG. 1, the proposed system for identifying one or more entities and semantic relations between one or more sentences, (102) (interchangeably referred to as system (102), herein) is disclosed and configured with voice into text converter (106), and with one or more output devices 108-1, 108-2 . . . 108-N(collectively referred to as output devices (108), and individually referred to as output device (108), herein), which are associated with one or more users (110-1, 110-2 . . . 110-N) (collectively referred as users (110), and individually referred to as user (110), and a server (112), coupled with one another through a network (104) (interchangeably referred to as networking module (104), herein).

In an illustrative embodiment, the server (112) can be interchangeably referred to as controller. In another illustrative embodiment, the controller can be configured through the server (112) with help of the networking module (104). In another illustrative embodiment, the server (112) can be in communication with the output device (108) through a communication module, where the communication module can include any or a combination of Wireless local area network (WLAN), Wireless fidelity (Wi-fi), Worldwide interoperability for microwave access (WiMAX) where the communication module can facilitate long distance communication between the server (112) and the output device (108).

In an embodiment, the voice into text converter (106) and the output device (108) can communicate with the system (102) through the networking module (104), where the output device (108) can include any or a combination of cell phones, mobiles, laptops, computers, a smart camera, a smart phone, a portable computer, a personal digital assistant, a handheld device, computer, and the likes. In another embodiment, the voice into text converter (106) can be configured with the output device (108), where the voice into text converter (106) can be configured to receive an audio signal pertaining to speech from the user (110), and correspondingly convert the audio signals into the one or more sentences and correspondingly generate a first set of signals. In an illustrative embodiment, the user (110) can include any or a combination of person, human, and the like.

In an illustrative embodiment, the voice to text converter (106) can be in communication with the output device (108) through the communication module. In another illustrative embodiment, the voice to text converter (106) can be in communication with the system (102) through the networking module (104). In yet another illustrative embodiment, the output device (108) can be in communication with the system (102) through the network (104).

In an illustrative embodiment, the system (102) can facilitate identifying one or more entities and semantic relation between one or more sentences. The system (102) can include a processor configured with Entity agnostic semantic engine and facilitates identifying one or more entities and semantic relations between one or more sentences and can understand meaning and one or more entities from about 100 different languages, with fine-tuning required for at least one language. In another illustrative embodiment, the one or more entities can include any or a combination of noun, vowel, consonant, pronoun, digit, and the likes. In yet another illustrative embodiment, the one or more entities can be associated with pre-defined categories, where the pre-defined categories can include any or a combination of person names, organizations, locations, medical codes, time expressions, quantities, monetary values, percentages, numeral, and POS tags including NOUN, PER, ORG, etc.

In an illustrative embodiment, the system (102) can help entity agnostic semantic engine with cross lingual pre-training to reliably attain semantic learning for multiple languages and can facilitate in entity agnostic semantic similarity for low resource languages with zero shot transfer for both semantic similarity and named entity recognition (NER). In another illustrative embodiment, the system (102) can enable in detailed level of comparison for two sentences rather than relying on a single number which tries to account for both semantic and one or more entities difference and enables in leveraging cross lingual language solution to provide this level of detail even for low resource languages.

In an illustrative embodiment, the system (102) can help in identifying one or more entities and semantic relation that enables in identifying why two sentences are dissimilar (semantically different or entity based difference) enables in appropriately identifying similar/dissimilar sentences along with appropriate cause and enables in computing semantic similarity where entities are handled separately and do not effect meaning of the sentence. In another illustrative embodiment, the network (104) can be extended to provide an improved paraphrase mining solution based on proper semantic and entity similarity.

In an embodiment, the system (102) can be implemented using any or a combination of hardware components and software components such as a cloud, a server (112), a computing system, a computing device, a network device and the like. Further, the voice to text converter (106) can interact with the output device (108) and the server (112) through plurality of networking module (104), such as Wi-Fi, Bluetooth, Li-Fi, or an application, that can reside in the output device (108). In an implementation, the system (102) can be accessed by the networking module (102) or a server (112) that can be configured with any operating system, including but not limited to, Android, iOS™, and the like.

Further, the networking module (104) can be a wireless network, a wired network or a combination thereof that can be implemented as one of the different types of networks, such as Intranet, Local Area Network (LAN), Wide Area Network (WAN), Internet, and the like. Further, the networking module (102) can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), and the like.

According to various embodiments of the present disclosure, the system (102) can provide for an Artificial Intelligence (AI) based automatic speech detection and speech query generation by using signal processing analytics. In an illustrative embodiment, the speech processing AI techniques can include, but not limited to, a Natural Language Processing Algorithm, said algorithm can be any or a combination of machine learning (referred to as ML hereinafter), deep learning (referred to as DL hereinafter), and natural language processing (referred to as NLP hereinafter). Said algorithm and other data or speech model involved in the use of said algorithm can be accessed from a database in the server (112), through an interface Natural language Interface to Database (referred to as NLIDB hereinafter).

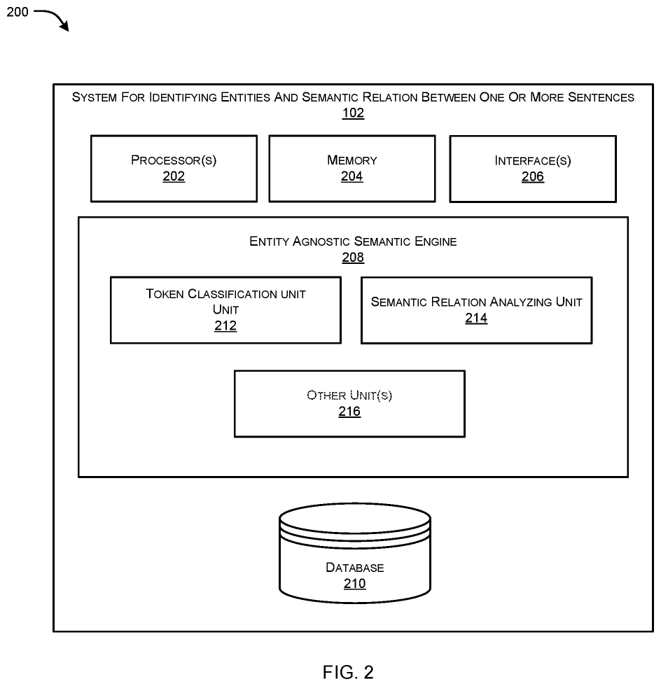

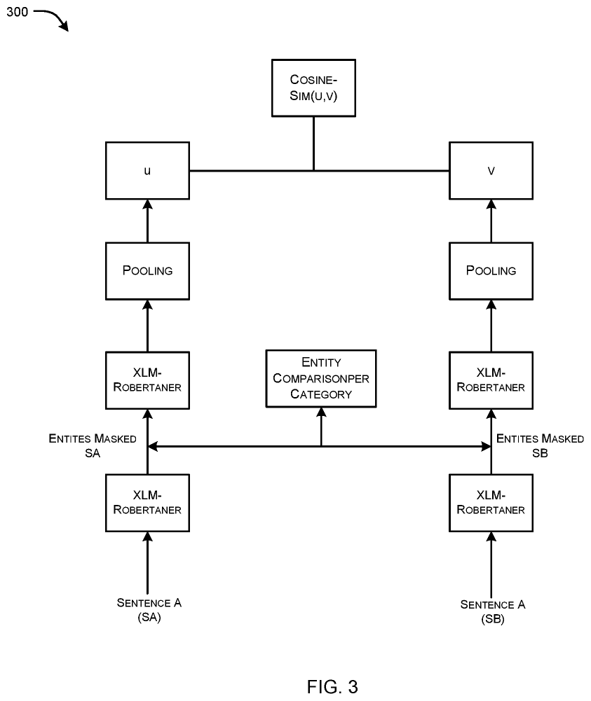

FIG. 2 and FIG. 3 illustrate exemplary functional components of the proposed system for identifying entities and semantic relations between one or more sentences, in accordance with an embodiment of the present disclosure.

As illustrated in an embodiment, the system (102) can include one or more processor(s) (202). The one or more processor(s) (202) can be implemented as one or more microprocessors, microcomputers, microcontrollers, digital signal processors, central processing units, logic circuitries, and/or any devices that manipulate data based on operational instructions. Among other capabilities, the one or more processor(s) (202) are configured to fetch and execute computer-readable instructions stored in a memory (204) of the system (102). The memory (204) can store one or more computer-readable instructions or routines, which may be fetched and executed to create or share the data units over a network service. The memory (204) can include any non-transitory storage device including, for example, volatile memory such as RAM, or non-volatile memory such as EPROM, flash memory, and the like.

In an embodiment, the system (102) can also include an interface(s) (206). The interface(s) (206) may include a variety of interfaces, for example, interfaces for data input and output devices, referred to as I/O devices, storage devices, and the like. The interface(s) (206) may facilitate communication of the system (102) with various devices coupled to the system (102). The interface(s) (206) may also provide a communication pathway for one or more components of system (102). Examples of such components include, but are not limited to, Entity agnostic semantic engine(s) (208) and database (210).

In an embodiment, the Entity agnostic semantic engine(s) (208) can be implemented as a combination of hardware and programming (for example, programmable instructions) to implement one or more functionalities of the Entity agnostic semantic engine(s) 208. In examples described herein, such combinations of hardware and programming may be implemented in several different ways. For example, the programming for the Entity agnostic semantic engine(s) (208) may be processor executable instructions stored on a non-transitory machine-readable storage medium and the hardware for the Entity agnostic semantic engine(s) (208) may include a processing resource (for example, one or more processors), to execute such instructions. In the present examples, the machine-readable storage medium may store instructions that, when executed by the processing resource, implement the Entity agnostic semantic engine(s) (208). In such examples, the system (102) can include the machine-readable storage medium storing the instructions and the processing resource to execute the instructions, or the machine-readable storage medium may be separate but accessible to system (102) and the processing resource. In other examples, the Entity agnostic semantic engine(s) (208) may be implemented by electronic circuitry. A database (210) can include data that is either stored or generated as a result of functionalities implemented by any of the components of the Entity agnostic semantic engine(s) (208).

In an embodiment, the Entity agnostic semantic engine(s) (208) can include a token classification unit (212), semantic relation analyzing unit (214), and other unit(s) (218). The other unit(s) (218) can implement functionalities that supplement applications or functions performed by the system (102) or the Entity agnostic semantic engine(s) (208).

The database (210) can include data that is either stored or generated as a result of functionalities implemented by any of the components of the Entity acoustic semantic engine(s) (208).

As illustrated in FIG. 2, the system (102) can include a processor (202), where the processor (202) can be configured to receive a first set of signals from a voice and text converter (106). In an illustrative embodiment, the voice and text converter (106) can be configured to convert an audio signal pertaining to speech into one or more sentences and correspondingly generate the first set of signals, where the first set of signals can be in machine readable form or binary form. In another illustrative embodiment, the token classification unit (212) can include an extraction unit, where the first set of signals are received and the extraction unit can facilitate extracting pre-defined categories from the first set of signals, where the pre-defined categories can include one or more entities.

In an illustrative embodiment, the pre-defined categories can include any or a combination of person names, organizations, locations, medical codes, time expressions, quantities, monetary values, percentages, numeral, POS tags like NOUN, PER, ORG, and the like. In another illustrative embodiment, the one or more entities can include any or a combination of noun, vowel, consonant, pronoun, digit, and the like. In yet another illustrative embodiment, the extraction unit can be configured to extract the pre-defined categories from the one or more sentences. In another illustrative embodiment, the extraction unit can be configured to identify the pre-defined categories from the one or more sentences.

In an illustrative embodiment, the token classification unit (212) can be configured to classify the pre-defined categories by assigning a pre-defined weight, wherein the pre-defined weight pertains to one or more trainable parameters. In another illustrative embodiment, the pre-defined weight can pertain to trainable parameters or model parameters like weights, and biases. In another illustrative embodiment, the token classification unit (212) can be configured to classify the pre-defined categories with help of assigning one or more trainable parameters.

In an illustrative embodiment, after classification of the pre-defined categories by assigning pre-defined weight, the token classification unit (212) can be configured to send the classified pre-defined categories to the semantic relation analyzing unit (214). In another illustrative embodiment, the semantic relation analyzing unit (214) can be configure to mask out each of the classified one or more entities of the pre-defined category with a dataset, where the dataset can include pre-stored filler alphanumeric characters for each of the one or more entities of the pre-defined categories. In yet another illustrative embodiment, the pre-stored filler alphanumeric characters can include number, and alphabet, where the pre-stored filler alphanumeric characters can be stored in the database (210). The pre-stored filler alphanumeric characters can be used to replace the one or more entities of similar pre-defined categories.

In an illustrative embodiment, the pre-stored filler alphanumeric characters include any or a combination of number, and alphabet, can be configured to replace the one or more entities of similar pre-defined categories. In another illustrative embodiment, the semantic relation analyzing unit (214) can be configured to mask out or replace the one or more entities (with a filler entity of the same category) and facilitate computing semantic similarity and along with, can compute category-wise (PER, LOC, ORG, 0, numeral) entity difference between the one or more sentences.

In an illustrative embodiment, the semantic relation analyzing unit (214) can be configured to calculate a semantic relation based on the masked out each of the one or more entities and facilitate computing semantic similarity for each of the one or more entities and difference between the one or more sentences, where the semantic relation can be calculated in multiple languages. In another illustrative embodiment, the semantic relation analyzing unit (214) can be configured to transmit the calculated semantic relation to an output device (108), where the output device (108) can be communicatively coupled to the processor (202) through a communication module. In yet another illustrative embodiment, the output device (108) can be configured to display the difference between the one or more sentences.

In an illustrative embodiment, the other unit(s) (216) can include a cross lingual semantic analysis unit configured to identify semantic relation pertaining to semantic similarity and difference in multiple languages. In another illustrative embodiment, the cross lingual semantic analysis unit (216) can facilitate in identifying the semantic relation in multiple languages, where multiple languages can be stored in the database (210) of the system (102). The semantic relation analyzing unit (214) can be configured to identify the difference or similarity between the one or more sentences, and the one or more entities involved in the one or more sentences.

In an illustrative embodiment, the cross lingual semantic analysis unit can be configured to train to understand multiple languages and helps in identifying the difference and similarity between the one or more sentences. In another illustrative embodiment, the semantic relation can include semantic similarity and pre-defined category-wise each of the one or more entities difference between the one or more sentences, where the difference can include semantic difference or one or more entities based difference. In another illustrative embodiment, the processor (202) is configured to capture one or more sentences which are semantically similar and mention different one or more entities, semantically different and mention same one or more entities, semantically similar with same one or more entities and also the one or more sentences dissimilar semantically and one or more entities wise.

In an illustrative embodiment, the semantic relation analyzing unit (214) can be configured to identify difference in one or more entities separately along with semantic similarity. In another illustrative embodiment, the semantic relation analyzing unit (214) can be configured to mask out or replace the one or more entities (with a filler entity of the same category) while computing semantic similarity and along with it compute the category-wise (PER, LOC, ORG, 0, numeral) entity difference between the one or more sentences and can help in finding source of the difference or similarity between the one or more sentences. In yet another illustrative embodiment, the processor (202) can be configured to capturing sentences which are semantically similar but mention different one or more entities, semantically different but mention same one or more entities, semantically similar with same one or more entities and also sentences that are dissimilar semantically and one or more entities wise which is a much detailed level of comparison for two sentences rather than relying on a single number which tries to account for both semantic and one or more entities difference. In yet another illustrative embodiment, leveraging cross lingual language model can facilitate providing detail even for low resource languages.

In an illustrative embodiment, the processor (202) can be configured with improved Siamese architecture proposed in Sentence BERT which can masks one or more entities mentioned in the one or more sentences and can compute a semantic similarity score, with entity difference computed separately. In another illustrative embodiment, the semantic relation analyzing unit (214) can enable in identifying reason for dissimilarity between one or more sentences (semantically different or entity based difference) and can help appropriately identifying similar/dissimilar sentences along with appropriate cause. In yet another illustrative embodiment, the cross lingual semantic analysis unit can facilitate in identifying semantic relation in multiple languages using zero shot transfer, where zero shot transfer can help in differentiating between one or more sentences efficiently in multiple languages using a single network (104).

In an illustrative embodiment, the system (102) can require low training data, where the system (102) can be trained in one language and inference can be expected in more than hundred languages, and facilitates attaining multilingual or cross lingual capabilities. In another illustrative embodiment, the cross lingual capability can ensure that the system (102) only needs to be trained in just single language to be able to perform in multiple language. For example—the system (102) can be trained only in English and can perform task in Indic language which are significantly low resource. In yet another illustrative embodiment, the system (102) can facilitate providing separate comparison for objects/entities mentioned in one or more sentences and core meaning of the one or more sentences showing exactly how they are similar/dissimilar (in terms of entities or meaning).

In an illustrative embodiment, one or more sentences can be from any language

(XLM is pre trained on about 100 languages), where the system (102) can understand meaning and one or more entities from about 100 different languages, with fine-tuning required for at least one language, for instance, the model can be tuned just for English and on feeding Hindi (or any other language) sentences can work.

It would be appreciated that units being described are only exemplary units and any other unit or sub-unit may be included as part of the system (102). These units too may be merged or divided into super-units or sub-units as may be configured.

As illustrated in FIG. 3, the processor (202) can be configured with XLM-RoBERTa model fine tuned on NER task in the network (102) with shared weights as shown in sentence BERT. The XLM architecture can be used within the larger network and fine-tuned for one or more entities agnostic semantic similarity. Multiple fine tuning tasks and transfer fine tuning can facilitate improving results using similar multi task techniques. In an illustrative embodiment, using an XLM RoBERTa NER model not only helps with NER but due to cross lingual pre-training, the model can also reliably attains semantic learning for multiple languages. The cross-lingual model can enable entity agnostic semantic similarity for low resource languages. In yet another illustrative embodiment, zero shot transfer for both semantic similarity and NER can facilitate increased performance and can help in extracting true meaning and entities of the sentences being compared.

In an illustrative embodiment, the system (102) can facilitate in identifying Semantic similarity where the one or more entities can be handled separately and do not effect meaning of the one or more sentences. In another illustrative embodiment, the system (102) can be capable of cross lingual zero shot transfer (uses a cross lingual LM) and facilitate solving mentioned problem for multiple languages without any specialized fine tuning for low resource languages. In yet another illustrative embodiment, same network (104) can be extended to provide an improved paraphrase mining solution based on proper semantic and entity similarity.

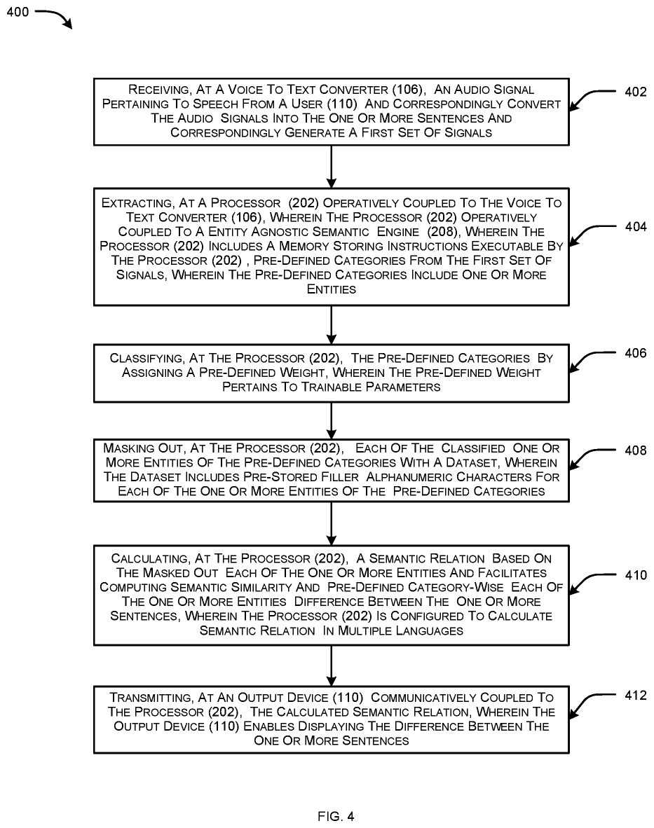

FIG. 4 illustrates an exemplary proposed method for identifying entities and semantic relations between one or more sentences, in accordance with an embodiment of the present disclosure.

In an embodiment, FIG. 4 illustrates a method for identifying entities and semantic relations between one or more sentences. The method (400) can include a step (402) of receiving, at a voice to text converter (106), an audio signal pertaining to speech from a user (110), and correspondingly convert the audio signals into the one or more sentences and correspondingly generate a first set of signals.

In an embodiment, the method (400) can include a step (404) of extracting, at a processor (202) operatively coupled to the voice to text converter (106), where the processor (202) can be operatively coupled to an Entity agnostic semantic engine (208), where the processor (202) can includes a memory storing instructions executable by the processor (202), pre-defined categories from the first set of signals, where the pre-defined categories can include one or more entities.

In an embodiment, the method (400) can include a step (406) of classifying, at the processor (202), the pre-defined categories by assigning a pre-defined weight, where the pre-defined weight pertains to one or more trainable parameters.

In an embodiment, the method (400) can include a step (408) of masking out, at the processor (202), each of the classified one or more entities of the pre-defined categories with a dataset, where the dataset can include pre-stored filler alphanumeric characters for each of the one or more entities of the pre-defined categories.

In an embodiment, the method (400) can include a step (410) of calculating, at the processor (202), a semantic relation based on the masked out each of the one or more entities and facilitates computing semantic similarity and pre-defined category-wise each of the one or more entities difference between the one or more sentences, where the processor (202) can be configured to calculate semantic relation in multiple languages.

In an embodiment, the method (400) can include a step (412) of transmitting, at an output device (108) communicatively coupled to the processor (202), the calculated semantic relation, where the output device (108) can enable displaying the difference between the one or more sentences.

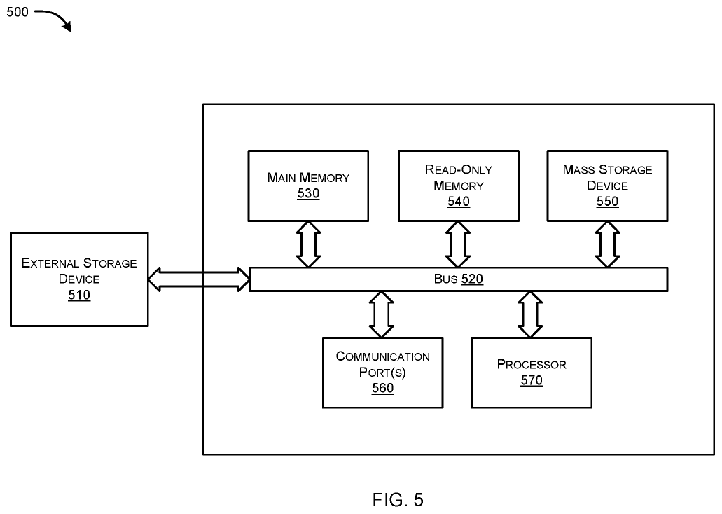

FIG. 5 illustrates an exemplary computer system in which or with which embodiments of the present invention can be utilized in accordance with embodiments of the present disclosure.

As shown in FIG. 5, computer system includes an external storage device 510, a bus 520, a main memory 530, a read only memory 540, a mass storage device 550, communication port 560, and a processor 570. A person skilled in the art will appreciate that computer system may include more than one processor and communication ports. Examples of processor 570 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 570 may include various modules associated with embodiments of the present invention. Communication port 560 can be any of an RS-232 port for use with a modem based dialup connection, a 10/100 Ethernet port, a Gigabit or 10 Gigabit port using copper or fiber, a serial port, a parallel port, or other existing or future ports. Communication port 560 may be chosen depending on a network, such a Local Area Network (LAN), Wide Area Network (WAN), or any network to which computer system connects.

In an embodiment, the memory 530 can be Random Access Memory (RAM), or any other dynamic storage device commonly known in the art. Read only memory 540 can be any static storage device(s) e.g., but not limited to, a Programmable Read Only Memory (PROM) chips for storing static information e.g., start-up or BIOS instructions for processor 570. Mass storage 550 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

In an embodiment, the bus 520 communicatively couples processor(s) 570 with the other memory, storage and communication blocks. Bus 520 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 570 to software system.

In another embodiment, operator and administrative interfaces, e.g. a display, keyboard, and a cursor control device, may also be coupled to bus 520 to support direct operator interaction with computer system. Other operator and administrative interfaces can be provided through network connections connected through communication port 560. External storage device 510 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a system and method for identifying entities and semantic relations which has low training data requirement and where by training an architecture in single language, inference in more than hundred languages.

The present disclosure provides a system and method that helps named entity recognition with cross lingual pre-training to reliably attain semantic learning for multiple languages.

The present disclosure provides a system and method that facilitates much detailed level of comparison for two sentences rather than relying on a single number which tries to account for both semantic and entity difference and enables in leveraging cross lingual language solution to provide this level of detail even for low resource languages.

The present disclosure provides a system and method that enables in identifying why two sentences are dissimilar (semantically different or entity based difference) and enables in appropriately identifying similar/dissimilar sentences along with appropriate cause.

The present disclosure provides a system and method for identifying entities and semantic relation where entities are handled separately and do not effect meaning of the sentence.

The present disclosure provides a system and method for identifying entities and semantic relation where same network is extended to provide an improved paraphrase mining solution.

We claim:

1. A system (102) for identifying one or more entities and semantic relations between one or more sentences, the system (102) comprising
a voice to text converter (106) configured to receive an audio signal pertaining to speech from a user (110), and correspondingly convert the audio signals into the one or more sentences and correspondingly generate a first set of signals;
a processor (202) in communication with the voice to text converter (106), wherein the processor (202) is operatively coupled to an Entity agnostic semantic engine (208), wherein the processor (202) includes a memory storing instructions executable by the processor (202) to:
extract pre-defined categories from the first set of signals, wherein the pre-defined categories include the one or more entities;
classify the pre-defined categories by assigning a pre-defined weight, wherein the pre-defined weight pertains to one or more trainable parameters;
mask out each of the classified one or more entities of the pre-defined categories with a dataset, wherein the dataset includes pre-stored filler alphanumeric characters for each of the one or more entities of the pre-defined categories;
calculate a semantic relation based on the masked out each of the one or more entities and facilitates computing semantic similarity and pre-defined category-wise each of the one or more entities difference between the one or more sentences,
wherein the processor is configured to calculate semantic relation in multiple languages;
wherein the processor is configured to transmit the calculated semantic relation to an output device (110) communicatively coupled to the processor (202), wherein the output device (110) enables displaying the difference between the one or more sentences.

2. A system (102) for identifying one or more entities and semantic relations between one or more sentences as claimed in claim 1, wherein the pre-defined categories include any or a combination of person names, organizations, locations, medical codes, time expressions, quantities, monetary values, percentages, numeral, and POS tags including NOUN, PER, ORG, etc.

3. A system (102) for identifying one or more entities and semantic relations between one or more sentences as claimed in claim 1, wherein the one or more entities include any or a combination of noun, vowel, consonant, pronoun, and digit.

4. A system (102) for identifying one or more entities and semantic relations between one or more sentences as claimed in claim 1, wherein the pre-stored filler alphanumeric characters include any or a combination of number, and alphabet, to replace the one or more entities of similar pre-defined categories.

5. A system (102) for identifying one or more entities and semantic relations between one or more sentences as claimed in claim 1, wherein the semantic relation includes semantic similarity and pre-defined category-wise each of the one or more entities difference between the one or more sentences, wherein the difference includes semantic difference or entity based difference.

6. A system (102) for identifying one or more entities and semantic relations between one or more sentences as claimed in claim 1, wherein the processor (202) is configured to capture one or more sentences which are semantically similar and mention different entities, semantically different and mention same entities, semantically similar with same entities and also the one or more sentences dissimilar semantically and entity wise.

7. A system (102) for identifying one or more entities and semantic relations between one or more sentences as claimed in claim 1, wherein the output device (108) includes one or more mobile computing devices, wherein the one or more mobile computing devices include any or a combination of cell phone, laptop, and digital handheld portable device.

8. A method (400) for identifying one or more entities and semantic relations between one or more sentences, the method (400) comprising
receiving, at a voice to text converter (106), an audio signal pertaining to speech from a user (110) and correspondingly convert the audio signals into the one or more sentences and correspondingly generate a first set of signals;
extracting, at a processor (202) operatively coupled to the voice to text converter (106), wherein the processor (202) operatively coupled to a Entity agnostic semantic engine (208), wherein the processor (202) includes a memory storing instructions executable by the processor (202), pre-defined categories from the first set of signals, wherein the pre-defined categories include the one or more entities;
classifying, at the processor (202), the pre-defined categories by assigning a pre-defined weight, wherein the pre-defined weight pertains to one or more trainable parameters;
masking out, at the processor (202), each of the classified one or more entities of the pre-defined categories with a dataset, wherein the dataset includes pre-stored filler alphanumeric characters for each of the one or more entities of the pre-defined categories;
calculating, at the processor (202), a semantic relation based on the masked out each of the one or more entities and facilitates computing semantic similarity and pre-defined category-wise each of the one or more entities difference between the one or more sentences,
wherein the processor (202) is configured to calculate semantic relation in multiple languages, and
transmitting, at an output device (110) communicatively coupled to the processor (202), the calculated semantic relation, wherein the output device (110) enables displaying the difference between the one or more sentences.

9. A method (400) for identifying entities and semantic relations between one or more sentences as claimed in claim 1, wherein the semantic relation includes semantic similarity and pre-defined category-wise each of the one or more entities difference between the one or more sentences, wherein the difference includes semantic difference or one or more entities based difference.

10. A method (400) for identifying entities and semantic relations between one or more sentences as claimed in claim 1, wherein the processor (202) is configured to capture one or more sentences which are semantically similar and mention different one or more entities, semantically different and mention same one or more entities, semantically similar with same one or more entities and also the one or more sentences dissimilar semantically and the one or more entities wise.
